(19) United States
(12) Patent Application Publication
(10) Pub. No.: US 2010/0201618 A1
(43) Pub. Date: Aug. 12, 2010

(54) USER INTERFACE

(75) Inventor: Carlos Zafra LORENTE, Barcelona (ES)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY ESPANA S.A., Barcelona (ES)

(21) Appl. No.: 12/619,138

(22) Filed: Nov. 16, 2009

(30) Foreign Application Priority Data
Feb. 12, 2009 (GB) 0902343.3

(51) Int. Cl. G06F 3/033; G06F 3/048

(52) U.S. Cl. 345/157; 715/841

(57) ABSTRACT

A user interface including a display driver and a control unit having a rotatable actuator. The display driver is configured to cause a display to display a plurality of selectable categories in a main array extending in a first direction, to display, for at least one of the categories, a respective plurality of selectable subcategories in a respective subarray extending in a second direction different to the first direction, to selectively highlight one of the categories and subcategories and to move highlighting between adjacent categories or subcategories in response to rotation of the rotatable actuator. The control unit includes an orientation sensor configured to detect whether the control unit is in a first orientation or a second orientation. The display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

### CROSS-REFERENCE TO RELATED APPLICATIONS

This application is based upon and claims the benefit of priority from British Application No. 0902343.3 filed 12 Feb. 2009, the entire contents of which are incorporated by reference.

### BACKGROUND OF THE INVENTION

1. Field of the Invention

The present invention relates to a user interface and a method of providing a user interface with a control unit for navigating categories and subcategories as displayed on a display.

2. Description of the Related Art

It is well known to provide to a user a user interface for accessing a plurality of categories and, for each category, a respective plurality of subcategories. The categories may relate to stored information, such as video, music, pictures and contacts. Alternatively or additionally, the categories may relate to functions of a device or a plurality of devices with subcategories relating to individual devices or being individual functions/items for a device.

It is known to display a plurality of selectable categories in a main array extending in the horizontal direction and to display, for each of those main categories, a respective plurality of selectable subcategories extending in a respective subarray in a vertical direction. An example of such a user interface is the XrossMediaBar (trade mark) as used for example on the handheld game machine, the Sony PlayStation Portable (PSP) (trade mark), as developed by Sony Computer Entertainment (trade mark).

Using the XrossMediaBar (trade mark) user interface, a user can use standard navigation keys (such as four arrow keys orientated at 90-degree intervals) first to scroll through horizontal main categories and then to scroll vertically through subcategories for a currently selected or highlighted main category.

### OBJECTS AND SUMMARY OF THE INVENTION

The present application is based at least partly on a recognition that it would be desirable to be able to navigate such a display in a more straightforward manner, perhaps using a smaller control unit or at least a control unit with fewer individual control keys.

According to the present invention, there is provided a method of providing a user interface using a control unit with a rotatable actuator. The method includes displaying a plurality of selectable categories in a main array extending in a first direction, displaying, for at least one of said categories, a respective plurality of selectable subcategories in a respective subarray extending in a second direction different to said first direction, selectively highlighting one of the categories and subcategories, and moving highlighting between adjacent categories or subcategories in response to rotation of the rotatable actuator. The control unit includes an orientation sensor configured to detect whether the control unit is in a first orientation or a second orientation. The method further includes moving the highlighting in the first direction between adjacent categories in response to rotation of the rotatable actuator when the control unit is in the first orientation, and moving highlighting in the second direction between adjacent subcategories in response to rotation of the rotatable actuator when the control unit is in the second orientation.

According to the present invention, there is also provided a user interface including a display driver and a control unit having a rotatable actuator. The display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator. The control unit includes an orientation sensor configured to detect whether the control unit is in a first orientation or a second orientation. The display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

In this way, it is possible to navigate both the main categories and the subcategories using the same rotatable actuator.

Determination that navigation of the subcategories is required can be made according to detection of the orientation of the control unit.

It thus becomes easier to construct a small control unit and/or a control unit having fewer functional keys.

In more general terms, the method of the invention provides for scrolling an image in the first direction in response to rotation of the rotatable actuator when the control unit is in the first orientation and scrolling of the image in the second direction in response to rotation of the rotatable actuator when the control unit is in the second orientation. Hence, the invention may also provide a display driver responsive to the orientation sensor and configured to scroll an image in the first direction in response to rotation of the rotatable actuator when the controller is in the first orientation and to scroll the image in the second direction in response to rotation of the rotatable actuator when the control unit is in the second orientation.

Preferably, the user interface is responsive to detection of a change from the first orientation to the second orientation to select the highlighted one of the categories at the time of detection of the change of orientation.

In this way, it is not necessary for a user to use any other keys or actuators than the rotatable actuator in order to navigate the categories and subcategories.

The control unit could be provided with a second actuator. In this case, the user interface could be responsive to actuation of the secondary actuator to select a currently highlighted one of the categories and subcategories.

Thus, the secondary actuator could be used to confirm selection of a category before re-orientating the control unit for navigation of the respective subcategories. Irrespective, the secondary actuator could be used for final selection of any individual subcategory.

Preferably, the secondary actuator is provided together with the rotatable actuator.

To operate the secondary actuator, the rotatable actuator might be moved or pressed in a direction other than its normal rotatable direction, for instance be pressed inwardly of the body of the control unit.

The control unit itself may be provided with a display for displaying at least the main array of categories when the control unit is in the first orientation and the subarray of categories when the control unit is in the second orientation.

In this way, the user interface could be provided in the control unit itself, for instance as might be the case in a handheld entertainment device or portable telephone. As will be explained in the detailed description which follows, the display could display only part of the main array or subarray at any one time.

In response to selection of one of the categories, the display driver is preferably configured to cause the display to display only the respective subarray of categories for that selected category.

Where displays have an extent sufficient to display both categories and subcategories in the two available dimensions, it is possible to display a plurality of categories and all of their respective subcategories at the same time. However, navigation is made more straightforward for a user if only one respective subarray of categories is displayed at any one time.

It is possible for the main array of categories to disappear from the display when the subarray of categories for a particular category is selected. However, where space permits on the display, it is preferred that the display displays simultaneously the main array of categories and the subarray of subcategories for a currently highlighted one of the categories.

In this respect, the main array and subarray may be displayed as part of a XrossMediaBar (trade mark) menu.

The rotatable actuator may be of any suitable known design. It may be an actual physical rotatable actuator or a virtual rotatable actuator, for instance, displayed on a touch-sensitive display. Examples of rotatable actuators include a member rotatable about an axis substantially perpendicular to the outer surface of the control unit, a member rotatable about an axis substantially parallel with and below the outer of the control unit and a touch-sensitive panel formed in or on the outer surface of the control unit.

The user interface may be provided in combination with a display. The display is preferably remote from the control unit. However, the display driver could be provided with the display.

The user interface can be provided as part of any suitable apparatus such as a television device, a gaming device, a telephone device and a computing device such as desktop or laptop.

Also, the present invention can be embodied in software for use on any such apparatus and for use with an appropriate control unit.

### BRIEF DESCRIPTION OF THE DRAWINGS

FIG. 1 illustrates schematically an example of a main array of categories;

FIG. 2 illustrates schematically a main array of categories after navigation;

FIG. 3 illustrates schematically a subarray of selective subcategories;

FIG. 4 illustrates schematically a control unit in combination with a display;

FIGS. 5(A) and (B) illustrate schematically re-orientation of a control unit;

FIG. 6 illustrates schematically display and scrolling of a general image;

FIG. 7 illustrates schematically display and navigation of a web page;

FIGS. 8(A) to (D) illustrate schematically examples of control actuators;

FIGS. 9(A) and a (B) illustrate schematically an example of a control unit;

FIGS. 10(A) and (B) illustrate schematically an example of a control unit;

FIG. 11 illustrates schematically functional component parts of a user interface according to the present invention; and

FIGS. 12(A) to (D) illustrate schematically examples of user interfaces embodying the present invention.

### DETAILED DESCRIPTION OF THE PREFERRED EMBODIMENTS

The invention will be more clearly understood from the following description, given by way of example only, with reference to the accompanying drawings.

It is known to provide menus and submenus by means of a graphical user interface having categories displayed (for instance by means of icons) in an array extending in a first direction and subcategories extending in respective subarrays in a second direction, normally perpendicular to the first direction. An example of such a menu arrangement is the XrossMediaBar (XMB) (trade mark).

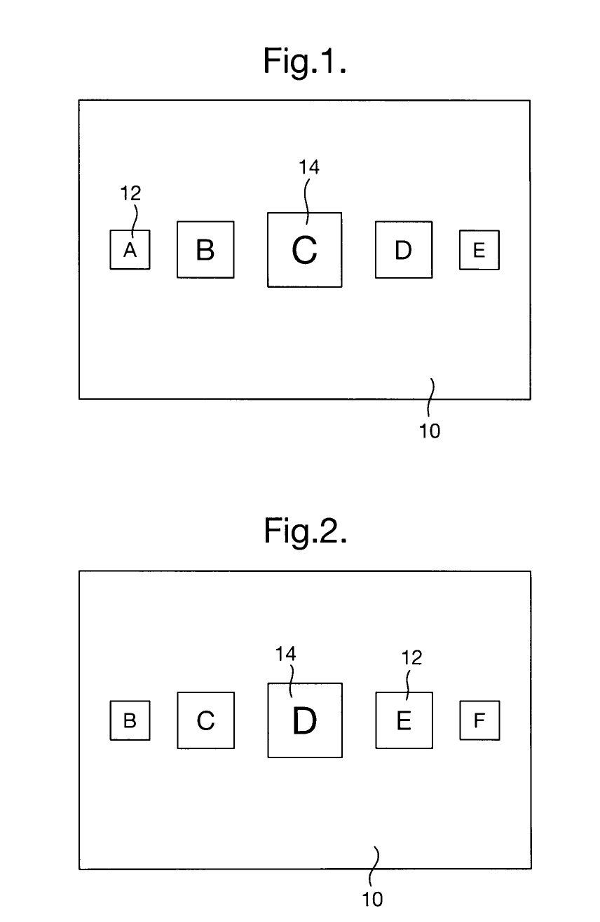

FIG. 1 illustrates schematically an example of a user interface display suitable for use with the present invention. As illustrated, a main array of main categories A, B, C, D an E are arranged in a horizontal direction across the display screen, each main category 12 being indicated by an appropriate image, such as an icon 12.

As illustrated, the category C is currently chosen for possible selection. This may be indicated to the user in any appropriate manner, for instance using some form of highlighting. In the illustrated example, the category is highlighted by being larger than the adjacent categories.

In a manner to be described below, the user interface allows a user to move the highlighting between adjacent categories. It is possible for the categories to remain in their designated positions on the display screen 10 and to move the highlighting in a left or right direction as required. However, in a preferred embodiment, when a user operates a control to move the highlighting, the highlighting position on the display screen 10 remains static. Hence, as illustrated, the central display position 14 is the highlighted position and, when a user moves the highlighting, the array of categories moves relative to the central highlighting position 14. Thus, as illustrated in FIG. 2, a user may move the highlighting relative to the main array by moving the main array and, thereby, highlighting category D as illustrated.

The present invention is intended for use with a menu which provides arrays of subcategories for one or more of the main categories.

If a user chooses to select a main category, namely the category currently in the central highlighted position 14, the user interface proceeds to display an array of subcategories available for that main category.

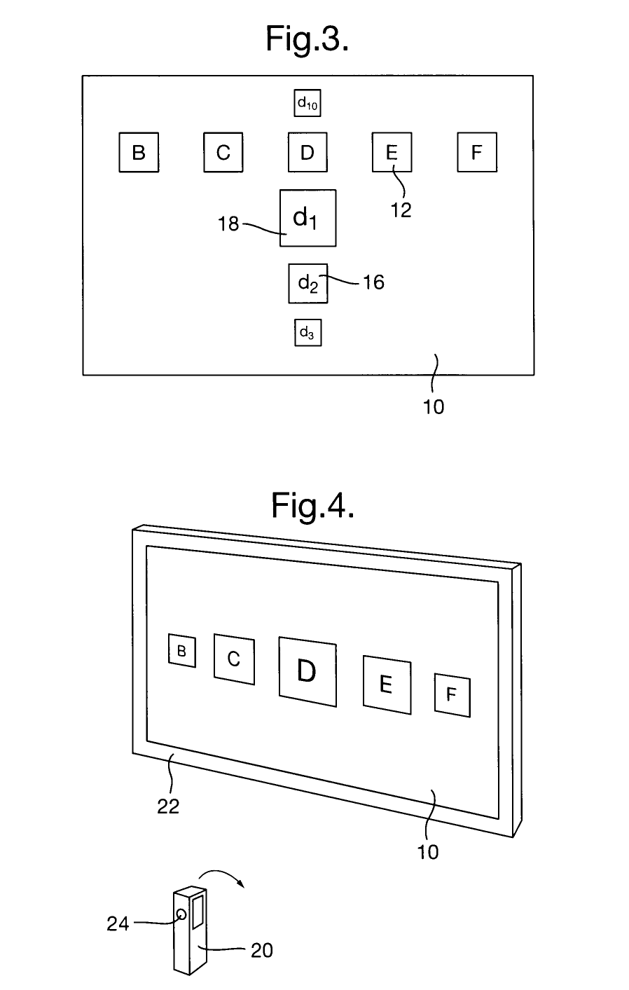

With the user interface considered here, as illustrated in FIG. 3, a subarray of subcategories 16 appears on the display screen 10 extending in a second direction, namely a vertical direction as illustrated.

As with the main array of main categories, the subarray of subcategories are displayed, for instance as icons 16, with one of the categories 18 highlighted. Once again any known means of highlighting could be used. However, in the illustrated embodiment, highlighting is achieved principally by a category appearing in a central position 18.

By means of a control to be described below, it is possible to move the highlighting relative to the subarray of subcategories. Once again, the highlighting could be moved relative to subcategories 16 remaining static on the display screen 10. However, in the preferred embodiment, the highlighted position 18 remains static and a user moves the subcategories relative to the highlighted position 18.

When a user has chosen a desired subcategory in the highlighted position 18, that subcategory could be chosen for any desired purpose according to the nature of the subcategories and the use of the user interface.

By way of example, a main category could be a movie and subcategories could be individual movies available for viewing.

Although it is possible to navigate a menu structure as described above using conventional navigation keys, for instance as found on a remote control device or gaming device, a user interface according to the present invention makes use of a rotatable actuator and an orientation sensor to facilitate navigation.

FIG. 4 illustrates schematically a control unit 20 for use with a display device 22 having the display 10. As illustrated, the display 10 shows the display of FIG. 2.

The control unit 20 is provided with a rotatable actuator 24 and an orientation sensor (internal of the control unit and hence not shown) for detecting the orientation of the control unit 20.

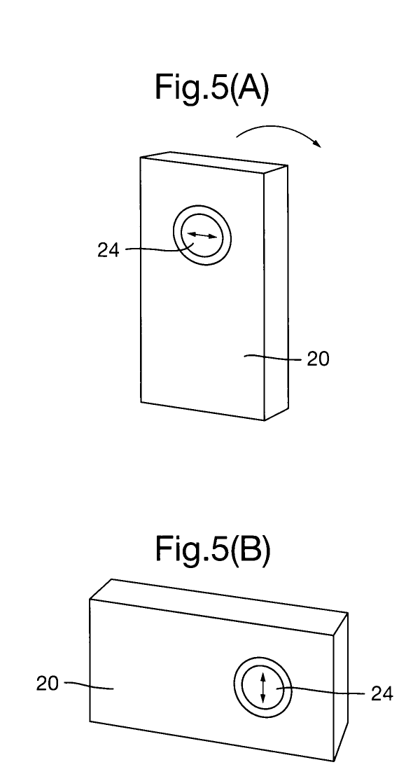

A similar control unit 20 is illustrated in FIGS. 5(A) and (B). With the control unit 20 in the orientation illustrated in FIG. 5(A), rotating the rotatable actuator 24 to the left or right will result in navigation through the categories of the main array, for instance moving the highlighting, by moving the categories relative to the central position as illustrated in FIGS. 1 and 2.

By means of the orientation sensor within the control unit 20, it is possible for the user interface to determine that the user wishes to navigate amongst subcategories. Thus, rotating the orientation of the control unit 20 from the first orientation shown in FIG. 5(A) to the second orientation shown in FIG. 5(B), for instance a change of orientation of 90 degrees, the user interface can determine that the user wishes to navigate to the sub array of subcategories for the currently highlighted main category. By way of example, starting with the main array illustrated in FIG. 2, reorientating the control unit 20 to the second orientation illustrated in FIG. 5(B) will result in the user interface moving to a display as illustrated in FIG. 3.

With the control unit 20 in the second orientation, rotation of the rotatable actuator 24 can then be used to navigate between the subcategories of the subarray as discussed above. It is possible for the user interface to navigate to a subarray of subcategories automatically upon reorienting the control unit 20. Alternatively or additionally, the control unit 20 may be provided with a secondary actuator for positively selecting the main category which happens to be highlighted at that time. Subsequent reorientation of the control unit 20 would then allow navigation in the direction of the subarray. The secondary actuator could be provided as a separate actuation device, such as a press-button. However, in the preferred embodiment, the actuator 24 is arranged not only to be rotatable but also to be depressible so as to operate as the secondary actuator.

Irrespective of use of the secondary actuator to select a main category, the secondary actuator can be used to select the highlighted subcategory, for instance category 18 as illustrated in FIG. 3.

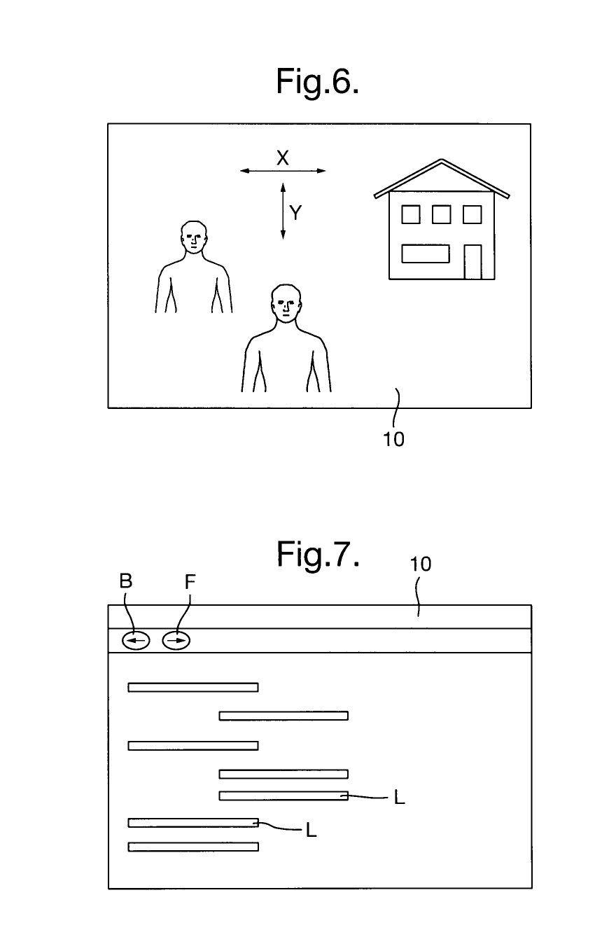

FIG. 6 illustrates a more general image displayed on the display screen 10. The image as displayed on the display screen 10 may be controlled by the control unit and its actuator 24 so as to scroll or move the image left and right and also up and down. This is particularly useful when the displayed image is only part of a larger complete image.

With the control unit in the first orientation as illustrated in FIG. 5(A), rotating the rotatable actuator 24 to the left or right will result in scrolling of the displayed image left or right as illustrated by arrow X in FIG. 6. By rotating the orientation of the control unit 20 from the first orientation shown in FIG. 5(A) to the second orientation shown in FIG. 5(B), for instance a change of orientation of 90°, the user interface can determine that the user wishes to scroll the displayed image up and down. With the control unit in the second orientation as illustrated in FIG. 5(B), rotation of the rotatable actuator 24 can thus be used to scroll the displayed image up and down as illustrated by arrow Y.

It is also possible for the displayed image to be scrolled at intermediate angles according to an intermediate orientation of the control unit 20.

The displayed image may be any appropriate image, such as a stored photograph. However, use of the control unit 20 may be particularly advantageous when web-browsing and the webpage being viewed is larger than the display screen 10.

Where an initially displayed image fits into the size of the display screen 10, it is possible to provide the control unit 20 and user interface with an additional function allowing zooming of the image. In particular, by rotating the control unit quickly, for instance about a vertical axis as illustrated in FIG. 5(A), so as to “spin” the control unit 20, the user interface can zoom in or out of the image according to the direction of spin.

In one embodiment, rotation or spinning of the actuator 24 can be used to zoom in or out of the displayed image according to the direction of rotation. Once the desired amount of zoom has been achieved, operation of the secondary actuator, for instance depressing the actuator 24, can control the user interface to change modes to the scroll mode as discussed above where movement of the actuator 24 causes scrolling either left and right or up and down.

When web-browsing, it is envisaged that the control unit 20 and user interface can also be used to navigate pages and items within a page.

FIG. 7 illustrates schematically the display screen 10 displaying a web-browsing image. As illustrated, the image includes a forward button F and a backwards button B for navigating the browser back and forward through its history of pages. For the illustrated display image, a series of links L, for instance hypertext or URLs, are displayed.

The control unit 20 may be used in conjunction with the user interface such that, with the control unit in the first orientation illustrated in FIG. 5(A), rotation of the actuator 24 left or right causes operation of the back or forward buttons. With the control unit 20 in the second orientation as illustrated in FIG. 5(B), rotation of the actuator 24 causes navigation between the respective links L. Selection of a particular link could be achieved by the user providing a long press or double press of the secondary actuator or in any known manner.

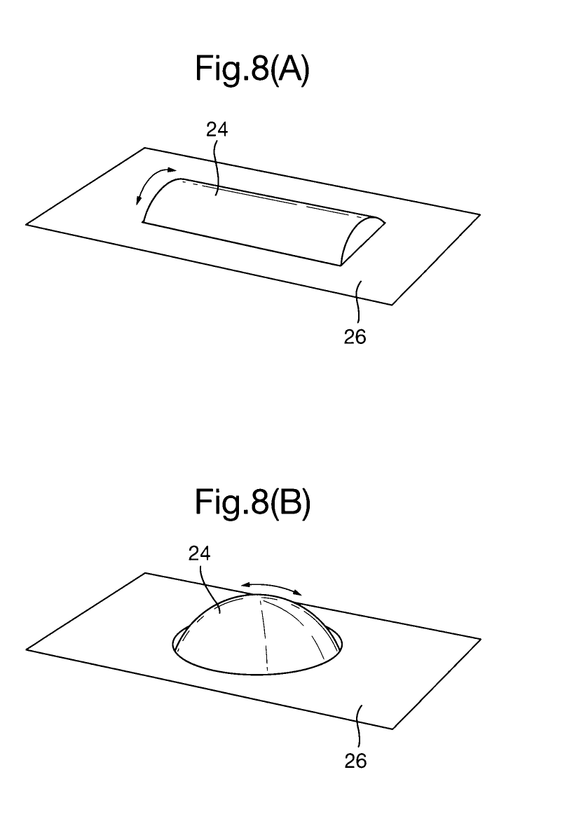

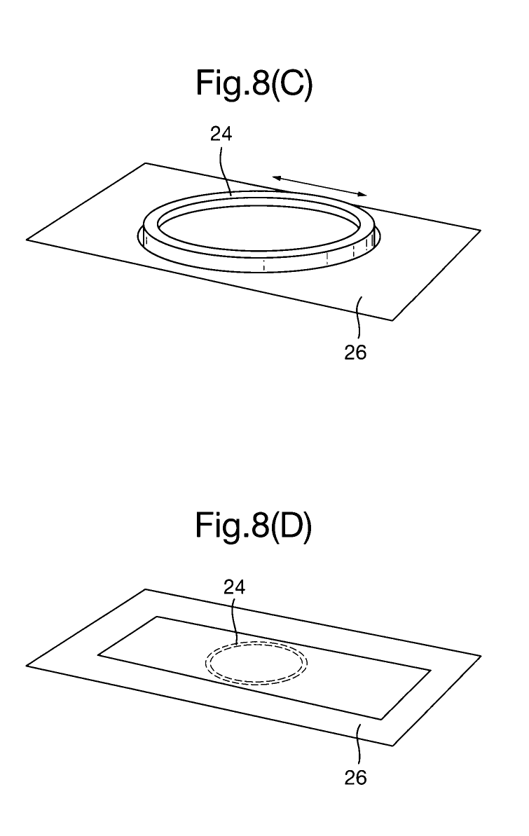

FIGS. 8(A) to (D) illustrate schematically alternative designs for the rotatable actuator 24.

The rotatable actuator 24 is preferably provided in an outer surface 26 of the control unit 20.

As illustrated in FIG. 8(A) the rotatable actuator 24 is a member, such as a wheel or cylinder, which rotates about an axis which is generally parallel to the outer surface 26. In a preferred embodiment, the axis of rotation will be beneath the outer surface 26 such that a user merely moves a tangential surface of the wheel or drum parallel to that outer surface.

Alternatively, as illustrated in FIG. 8(B) the rotatable actuator could take the form of a ball mounted in the outer surface 26. The control unit and user interface could respond to rotation of the ball in any direction. However, it will be appreciated that the user interface for navigating the main and subarrays need only use rotation in one direction for navigation.

In the arrangement of FIG. 8(C), the rotatable member 24 rotates about an axis generally perpendicular to the outer surface 26. With this arrangement, navigation in opposite directions along an array (or a sub array) is achieved by rotating the actuator 24 either clockwise or anti-clockwise. It will be appreciated that the rotatable actuator could also be provided by a touch-sensitive panel as illustrated in FIG. 8(D). In the example illustrated in FIG. 8(D), a wheel, such as described with reference to FIG. 8(C), is simulated in the touch-sensitive panel. Of course, it will be appreciated that a wheel such as illustrated in FIG. 8(A) could similarly be simulated.

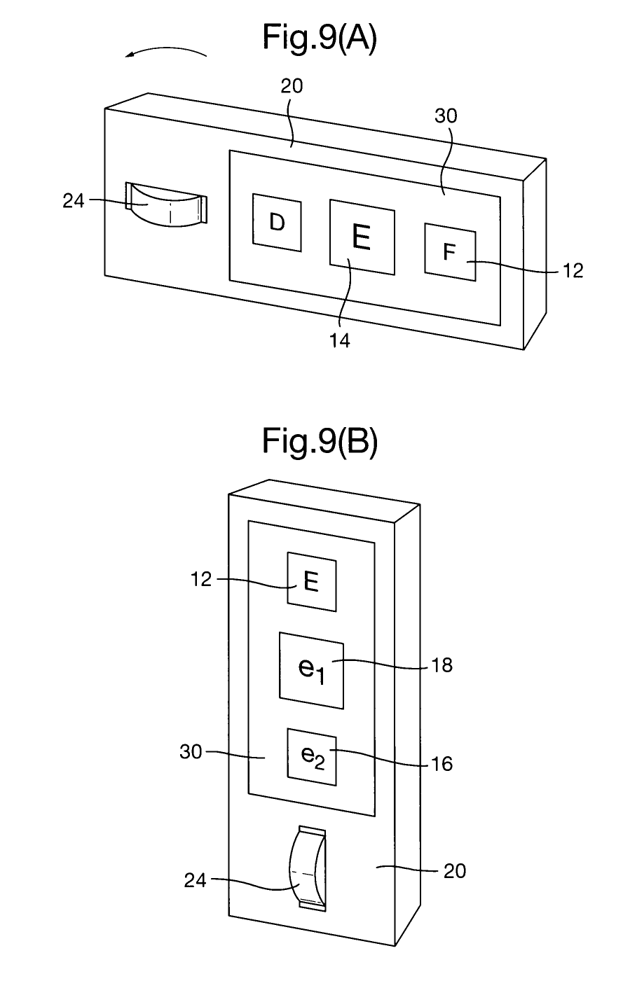

In the description given so far, it has been assumed that the display of the main and subarrays for the menu are displayed on a separate display screen 10. It is also possible for the control unit 20 to be provided with its own display screen 30 as illustrated in FIGS. 9(A) and (B). Such a control unit 20 could be used in conjunction with a separate display screen 10 or quite independently from any other display screen.

As illustrated in FIG. 9(A) with the control unit 20 in a first orientation, the display screen 30 displays a main array of main categories 12 with a central category 14 being highlighted. As discussed above, other means of highlighting the categories could alternatively be used.

When it is detected by the orientation sensor within the control unit 20 that the control unit 20 has been re-orientated to a second orientation such as illustrated in FIG. 9(B), the user interface navigates so as to display the subarray of subcategories for the main category that was highlighted at the time of the re-orientation. Thus, as illustrated in FIG. 9(B), the display screen 30 illustrates subcategories 16 with one subcategory 18 highlighted. The rotatable actuator 24 can then be used to navigate between the subcategories in the displayed subarray.

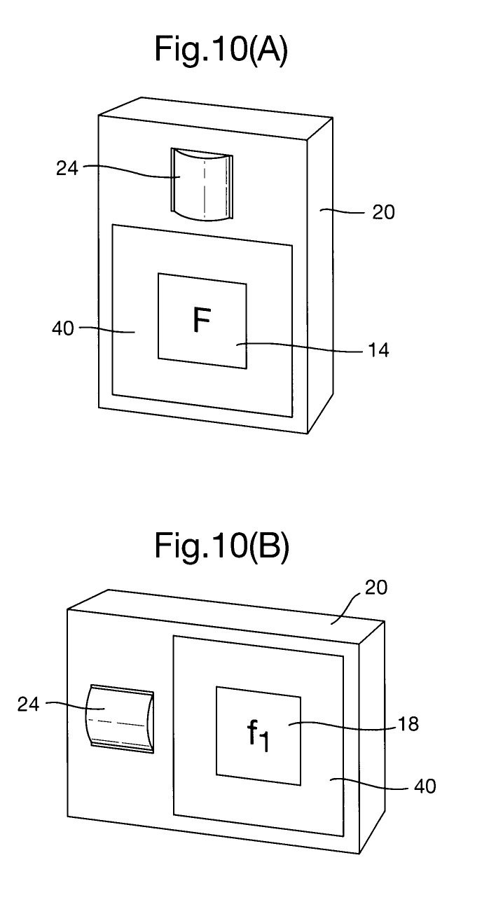

The control unit described with reference to FIGS. 9(A) and (B) includes a relatively elongate display 30 on which a plurality of categories or subcategories can be displayed simultaneously. It is also possible to provide a control unit as illustrated in FIGS. 10(A) and (B) in which the user interface displays on a display 40 of the control unit 20 only one category or subcategory at any one time.

With the control unit 20 orientated in the first orientation as illustrated in FIG. 10(A), actuation of the rotatable actuator 24 will cause each main category in turn to be displayed on the display 40. The category being displayed on the display 40 is taken to be the highlighted display. When the orientation sensor of the control unit 20 detects re-orientation to the second orientation illustrated in FIG. 10(B), the user interface navigates so as to display on the display 40 a subcategory of the main category at the time of re-orientation. The subcategory which is displayed is considered to be the highlighted subcategory 18.

Although the embodiments discussed above consider the first direction (having the main categories) being the horizontal direction and the second direction (having the subcategories) being the vertical direction, of course this could be reversed with the main categories arranged vertically and the subcategories arranged horizontally. Indeed, as most user interfaces have a combination of horizontal and vertical menu structures, the present invention could easily be applied to any such user interface.

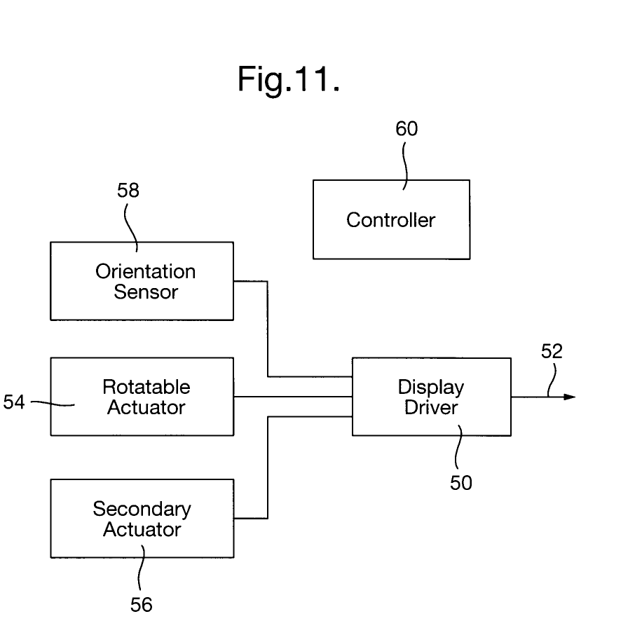

FIG. 11 illustrates schematically the functional component parts of a user interface embodying the present invention.

A display driver 50 is configured to provide an output 52 for display on a display device. As explained above, this could be one or both of an external display and a display integral with the control unit. The display driver 50 causes the display to display the appropriate main array and subarrays of categories to form the menu structure as described above. The display driver 50 may form part of a control unit or may be located in a separate device, for instance the display device.

The display driver 50 is in communication with a rotatable actuator 54 and a secondary actuator 56 (which may be formed integrally with the rotatable actuator 54 as described above). The display driver 50 is also in communication with an orientation sensor 58. One or more controllers 60 may be provided with appropriate processing and memory capabilities so as to facilitate the various functions of the user interface.

On the basis of signals received from the rotatable actuator and/or the secondary actuator, the display driver 50 changes its output 52 so as to navigate either along a main array of main categories or a subarray of subcategories. On the basis of a signal from the orientation sensor 58, the display driver 50 determines whether the navigation driven by the rotatable actuator 54 is along a main array or along a subarray.

It should be appreciated that the user interface can be embodied in many different devices.

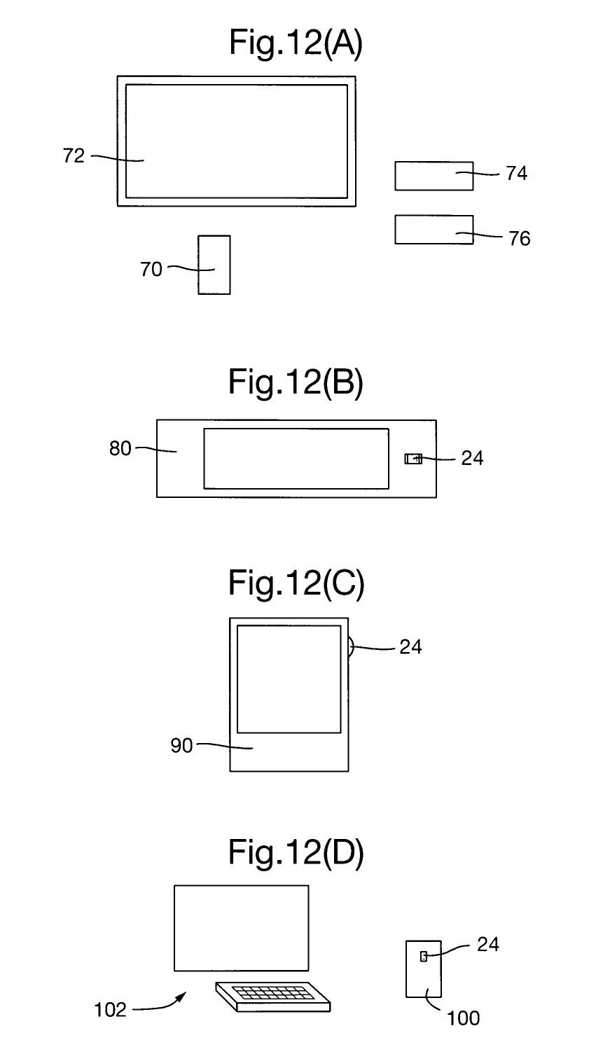

In FIG. 12(A) the control unit of the present invention is embodied in a remote control device 70 for use with one or more of a television display device 72, a television receiver device 74 and a television recording device 76. FIG. 12(B) illustrates the user interface embodied in a portable entertainment device 80 and FIG. 12(C) illustrates the user interface of the present invention embodied in a mobile telephone device 90. FIG. 12(D) illustrates schematically the user interface of the present invention embodied in a games console or computing device 100, 102.

We claim:

1. A user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

2. A user interface according to claim 1 configured to be responsive to detection by the orientation sensor of a change from the first orientation to the second orientation to select the highlighted one of the categories at the time of detection of the change from the first orientation to the second orientation.

3. A user interface according to claim 1 wherein the control unit has a secondary actuator and the user interface is configured to be responsive to actuation of the secondary actuator to select a currently highlighted one of the categories and subcategories

4. A user interface according to claim 3 wherein the secondary actuator is provided together with the rotatable actuator.

5. A user interface according to claim 1 wherein the control unit includes a display for displaying at least the main array of categories when said control unit is in the first orientation and a subarray of subcategories when said control unit is in the second orientation.

6. A user interface according to claim 1 wherein, in response to selection of one of the categories, the display driver is configured to cause the display to display only the respective subarray of categories for that selected category.

7. A user interface according to claim 1 wherein the display driver is configured to cause the display to display simultaneously the main array of categories and the subarray of subcategories for a currently highlighted one of the categories.

8. A user interface according to claim 7 wherein the display driver is configured to cause the display to display the main array and the subarray as part of an XrossMediaBar menu.

9. A user interface according to claim 1 wherein the rotatable actuator is on an outer surface of the control unit and is any one of:
a member rotatable about an axis substantially perpendicular to the outer surface;
a member rotatable about an axis substantially parallel with and below the outer surface; and
a touch-sensitive panel.

10. A user interface according to claim 1 in combination with a display remote from the control unit and configured to be driven by the display driver.

11. A television device comprising a user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

12. A portable entertainment device comprising a user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

13. A telephone device comprising a user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

14. A games console comprising a user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

15. A computing device comprising a user interface including:
a display driver; and
a control unit having a rotatable actuator; wherein:
the display driver is configured to cause a display to display a plurality of selectable categories in a main array extending in a first direction, to display, for at least one of said categories, a respective plurality of selectable subcategories in a respective subarray extending in a second direction different to said first direction, to selectively highlight one of the categories and subcategories and to move highlighting between adjacent categories or subcategories in response to rotation of the rotatable actuator;
the control unit includes an orientation sensor configured to detect whether the control unit is in a first orientation or a second orientation; and
the display driver is responsive to the orientation sensor and is configured to move highlighting in the first direction between adjacent categories in response to rotation of the rotatable actuator when the control unit is in the first orientation and to move highlighting in the second direction between adjacent subcategories in response to rotation of the rotatable actuator when the control unit is in the second orientation.

16. A method of providing a user interface using a control unit with a rotatable actuator, the method including:
displaying a plurality of selectable categories in a main array extending in a first direction;
displaying, for at least one of said categories, a respective plurality of selectable subcategories in a respective subarray extending in a second direction different to said first direction;
selectively highlighting one of the categories and subcategories; and
moving highlighting between adjacent categories or subcategories in response to rotation of the rotatable actuator; wherein
the control unit includes an orientation sensor configured to detect whether the control unit is in a first orientation or a second orientation and the method further includes:
moving the highlighting in the first direction between adjacent categories in response to rotation of the rotatable actuator when the control unit is in the first orientation; and
moving highlighting in the second direction between adjacent subcategories in response to rotation of the rotatable actuator when the control unit is in the second orientation.

17. A computer program comprising program code means for performing all the steps of claim 16 when said program is run on a computer.

18. A computer program product comprising program code means stored on a computer-readable medium for performing the method of claim 16 when said program product is run on a computer.
